(19) United States
(12) Patent Application Publication
(10) Pub. No.: US 2007/0182841 A1
(43) Pub. Date: Aug. 9, 2007

(54) Image sensing microelectronic device with glass tilt control features, and various methods of making same

(76) Inventors: Donnie Drake, Nampa, ID (US); Jorge Siqueiros, Boise, ID (US)

Correspondence Address: WILLIAMS, MORGAN & AMERSON, 10333 RICHMOND, SUITE 1100, HOUSTON, TX, 77042, US

(21) Appl. No.: 11/349,004

(22) Filed: Feb. 7, 2006

(51) Int. Cl. H04N 5/225

(52) U.S. Cl. 348/340

(57) ABSTRACT

Disclosed is an image sensing microelectronic device with glass tilt control features, and various methods of make same. In one illustrative embodiment, an image sensor die is disclosed which includes a substrate comprising an active area formed therein, a window positioned above the active area and a plurality of window tilt alignment features formed above the substrate, the window tilt alignment features being positioned between the window and the substrate.

### BACKGROUND OF THE INVENTION

1. Field of the Invention

The present invention generally relates to the field of manufacturing microelectronic devices, and, more particularly, to an image sensing microelectronic device with glass tilt control features, and various methods of make same.

2. Description of the Related Art

Microelectronic devices generally have a die (i.e., a chip) that includes integrated circuitry having a high density of very small components. In a typical process, a large number of die are manufactured on a single wafer using many different processes that may be repeated at various stages (e.g., implanting, doping, photolithography, chemical vapor deposition, plasma vapor deposition, plating, planarizing, etching, etc.). The die typically include an array of very small bond pads electrically coupled to the integrated circuitry. The bond pads are the external electrical contacts on the die through which the supply voltage, signals, etc. are transmitted to and from the integrated circuitry. The die are then separated from one another (i.e., singulated) by backgrinding and cutting the wafer. After the wafer has been singulated, the individual die are typically “packaged” to couple the bond pads to a larger array of electrical terminals that can be more easily coupled to the various power supply lines, signal lines and ground lines.

An individual die can be packaged by electrically coupling the bond pads on the die to arrays of pins, ball pads or other types of electrical terminals, and then encapsulating the die to protect it from environmental factors (e.g., moisture, particulates, static electricity and physical impact). For example, in one application, the bond pads can be electrically connected to contacts on an interposer substrate that has an array of ball pads. The die and a portion of the interposer substrate are then encapsulated with a covering.

Electronic products require packaged microelectronic devices to have an extremely high density of components in a very limited space. For example, the space available for memory devices, processors, displays and other microelectronic components is quite limited in cell phones, PDAs, portable computers and many other products. As such, there is a strong drive to reduce the height of the packaged microelectronic device and the surface area or “footprint” of the microelectronic device on a printed circuit board. Reducing the size of the microelectronic device is difficult because high performance microelectronic devices generally have more bond pads, which result in larger ball grid arrays and thus larger footprints.

Image sensor die present additional packaging problems. Image sensor die include an active area that is responsive to electromagnetic radiation. In packaging, it is important to cover and protect the active area without obstructing or distorting the passage of light or other electromagnetic radiation. Typically, an image sensor die is packaged by placing the die in a recess of a ceramic substrate and attaching a glass window to the die over the active area to hermetically seal the package.

FIG. 1 is an illustrative example of a prior art image sensor die 10 formed in a semiconducting substrate 12. The image sensor die 10 comprises a window or glass 14 that is positioned above an active area 18 formed in the substrate 12. The active area 18 typically contains a plurality of sensor cells (not shown) that are responsive to electromagnetic radiation that passes through the window 14. The image sensor die 10 further includes a plurality of bond pads 24 and a schematically depicted integrated circuit 20 that is electrically coupled to the bond pads 24 and the active area 18.

An adhesive or epoxy 16 is used to attach the window 14 to the substrate 12. In forming the image sensor die 10 depicted in FIG. 1, an adhesive dispensing tool is used to place or “work” a line of adhesive material on the image sensor die 10. Thereafter, using a vacuum tipped handling instrument, the window 14 is positioned slightly above the substrate 12 at the desired location above the active area 18. Once the alignment is deemed proper, the window 14 is simply dropped onto the previously formed line of adhesive material on the image sensor die 10.

One problem with the above methodology is that the window 14 may have any excessive amount of tilt. Ideally, the window 14 will be positioned exactly parallel to the surface 13 of the substrate 12. Any deviation from such a position is referred to as tilt. The window 14 may tilt in any direction, e.g., front-to-back, side-to-side, or a combination of both.

Tilt of the window 14 can be problematic for many reasons. Tilt can distort the light passing through the window 14, or even create dead spaces or areas within the active area 18 if the tilt is severe enough. In some cases, excessive tilt of the window 14 can necessitate removing the window 14 and reworking the process to try and produce an image sensor die 10 without an excessive amount of tilt. In other cases, the image sensor die 10 may simply be discarded.

The present invention is directed to a device and various methods that may solve, or at least reduce, some or all of the aforementioned problems.

### SUMMARY OF THE INVENTION

The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

The present invention is generally directed to an image sensing microelectronic device with glass tilt control features, and various methods of make same. In one illustrative embodiment, an image sensor die comprises a substrate comprising an active area formed therein, a window positioned above the active area and a plurality of window tilt alignment features formed above the substrate, the window tilt alignment features being positioned between the window and the substrate.

In another illustrative embodiment, an image sensor die comprises a substrate comprising an active area formed therein, a window positioned above the active area and two window tilt alignment features formed above the substrate, each of which are positioned on opposite sides of the active area, the window tilt alignment features being positioned between the window and the substrate, wherein the window contacts each of the window tilt alignment features.

In yet another illustrative embodiment, an image sensor die comprises a substrate comprising an active area formed therein, a window positioned above the active area and four window tilt alignment features formed above the substrate, each of which is positioned proximate a side of the active area, the window tilt alignment features being positioned between the window and the substrate, wherein the window contacts each of the window tilt alignment features.

In a further illustrative embodiment, an image sensor die comprises a substrate comprising an active area formed therein, a window positioned above the active area and four window tilt alignment features formed above the substrate, each of which is positioned proximate a corner of the active area, the window tilt alignment features being positioned between the window and the substrate, wherein the window contacts each of the window tilt alignment features.

In still a further illustrative embodiment, an image sensor die comprises a substrate comprising an active area formed therein, a window positioned above the active area and three window tilt alignment features formed above the substrate, the three window tilt alignment features being arranged in a triangular pattern around the active area, the window tilt alignment features being positioned between the window and the substrate, wherein the window contacts each of the window tilt alignment features.

In one illustrative embodiment, the method comprises forming a plurality of window tilt alignment features above a substrate of an image sensor die, the substrate comprising an active area. The method further comprises, after forming the plurality of window tilt alignment features, forming an adhesive material on the substrate, positioning a window above the active area and contacting the window with the adhesive material.

In another illustrative embodiment, the method comprises forming a plurality of window tilt alignment features above a substrate of an image sensor die, the substrate comprising an active area, wherein the plurality of window tilt alignment features are formed from a first adhesive material and are allowed to at least partially cure. The method further comprises, after forming the plurality of window tilt alignment features, forming a second adhesive material on the substrate, positioning a window above the active area and contacting the window with the second adhesive material.

In yet another illustrative embodiment, the method comprises forming a plurality of window tilt alignment features above a substrate of an image sensor die, the substrate comprising an active area, the forming of the plurality of window tilt control features comprising forming a layer of material above the substrate, forming a masking layer above the layer of material and performing an etching process to define the plurality of window tilt alignment features in the layer of material using the masking layer as an etch mask. The method further comprises, after forming the plurality of window tilt alignment features, forming an adhesive material on the substrate, positioning a window above the active area and contacting the window with the adhesive material.

In a further illustrative embodiment, the method comprises forming a plurality of window tilt alignment features comprised of a conductive material above a substrate of an image sensor die, the substrate comprising an active area. The method further comprises, after forming the plurality of window tilt alignment features, forming an adhesive material on the substrate, positioning a window above the active area and contacting the window with the adhesive material.

### BRIEF DESCRIPTION OF THE DRAWINGS

The invention may be understood by reference to the following description taken in conjunction with the accompanying drawings, in which like reference numerals identify like elements, and in which:

FIG. 1 is an example of an illustrative prior art image sensor die;

FIGS. 2A-2D are examples of an image sensor die with illustrative window tilt control features in accordance with various aspects of the present invention;

FIGS. 3A-3B are enlarged views of one illustrative example of a window tilt control feature in accordance with the present invention;

FIGS. 4A-4B are enlarged views of yet another illustrative example of a window tilt control feature in accordance with the present invention;

FIGS. 5A-5B are side views depicting an image sensor die comprised of illustrative window tilt control features in accordance with one aspect of the present invention;

FIGS. 6A-6B depict one illustrative method for forming the window tilt control features depicted herein; and

FIGS. 7A-7B depict yet another illustrative method for forming the window tilt control features depicted herein.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The present invention will now be described with reference to the attached figures. Although the various regions and structures of a semiconductor device are depicted in the drawings as having very precise, sharp configurations and profiles, those skilled in the art recognize that, in reality, these regions and structures are not as precise as indicated in the drawings. Additionally, the relative sizes of the various features depicted in the drawings may be exaggerated or reduced as compared to the size of those features or regions on fabricated devices. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be explicitly set forth in the specification in a definitional manner that directly and unequivocally provides the special definition for the term or phrase.

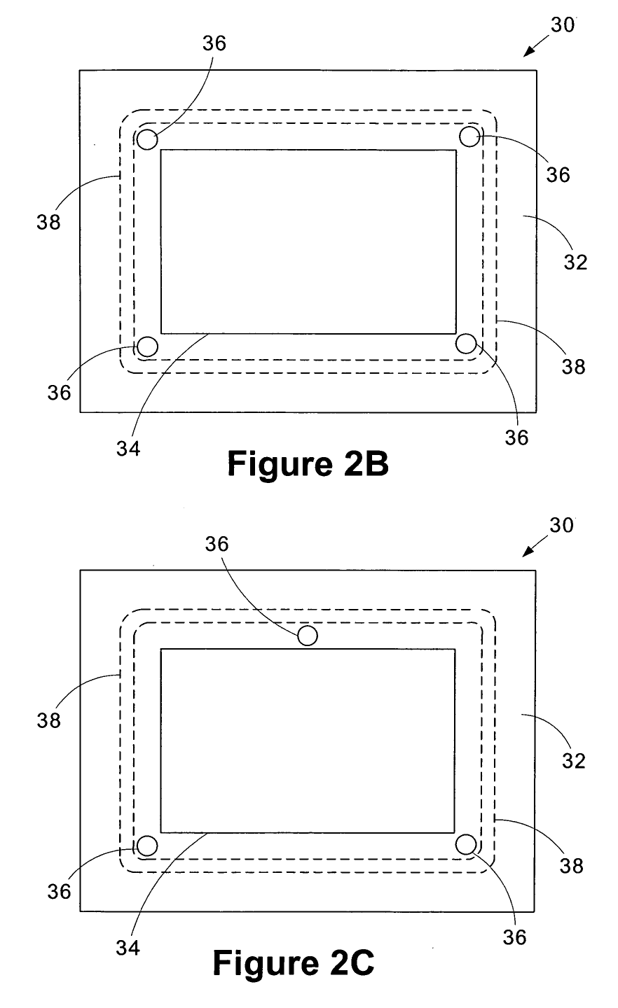

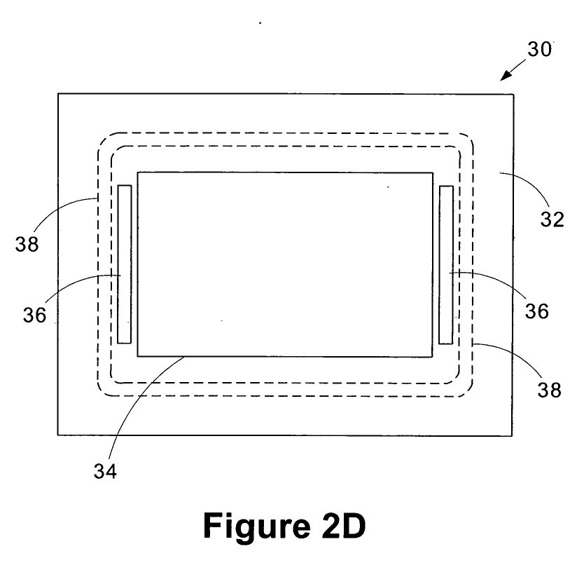

FIGS. 2A-2C are illustrative examples of an image sensor die 30 comprised of a plurality of window tilt control features 36. In FIG. 2A, the window tilt control features 36 are generally line-type features, whereas, in FIGS. 2B-2C, the window tilt control features 36 are circular bump-type features. After a complete reading of the present application, those skilled in the art will understand that the window tilt control features 36 described herein may be of any desired shape or configuration as long as they are capable of performing the functions described herein. Thus, the illustrative configuration and size of the window tilt control features 36 described herein should not be considered a limitation of the present invention.

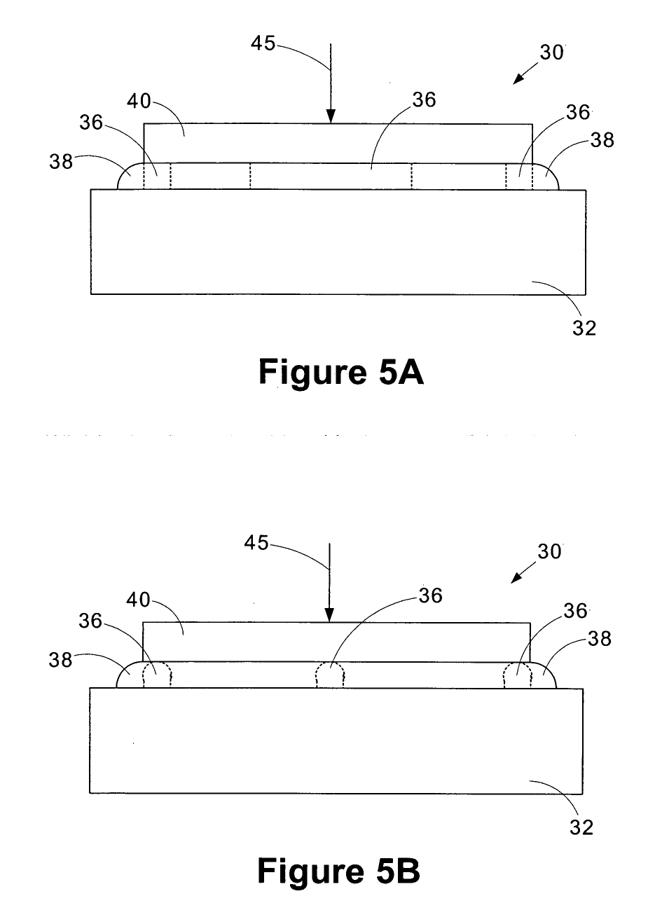

As to more specifics, the image sensor die 30 in FIGS. 2A-2C comprises a substrate 32 having an active area 34 formed therein. The dashed lines 38 in FIGS. 2A-2C depict the line of adhesive that will ultimately be formed to secure the window 40 (see FIGS. 5A-5B) to the substrate 32. In the depicted embodiment, the window tilt control features 36 are positioned between the active area 34 and the position of the line of adhesive.

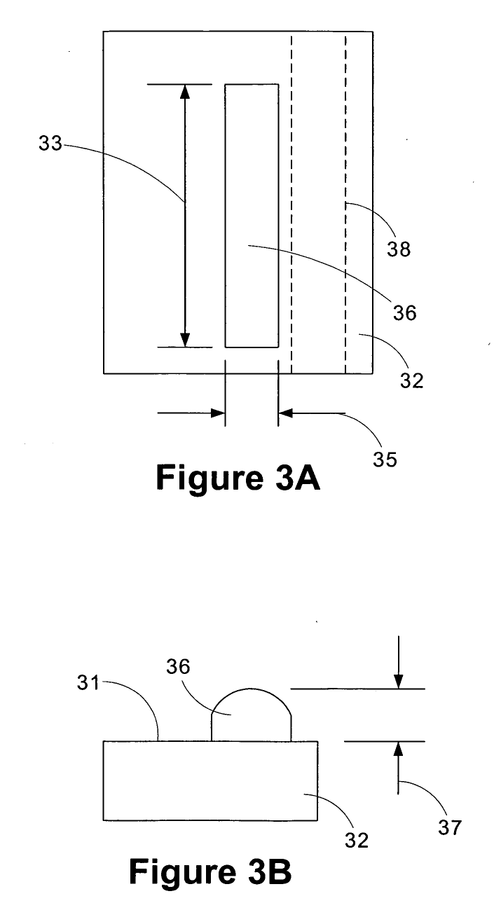

In FIG. 2A, the window tilt control features 36 are line-type features that are positioned around the perimeter of the active area 34. In the illustrative example depicted in FIG. 2A, each of the window tilt control features 36 is proximate the middle of each side of the active area 34. Of course, the end position of the window tilt control features 36 shown in FIG. 2A may vary depending on the particular application. FIGS. 3A-3B depict illustrative examples of the window tilt control features 36 shown in FIG. 2A. As shown therein, the window tilt control features 36 may have a length 33 that ranges from approximately 60-80% of the side of the active area 34, a width 35 that ranges from approximately 50-150 μm, and a height 37 that ranges from approximately 75-175 μm. Of course, such illustrative dimensions should not be considered as a limitation of the present invention.

FIG. 2B depicts yet another illustrative example of the present invention wherein the window tilt control features 36 have a generally rounded configuration, e.g., a circular or ball-shaped configuration. In FIG. 2B, the image sensor die 30 comprises four of the window tilt control features 36 positioned proximate the corners of the active area 34. In FIG. 2C, the image sensor die 30 comprises three of the window tilt control features 36 that are positioned in a triangular shaped pattern around the active area 34. The three window tilt control features 36 depicted in FIG. 2C define a plane that may be used to assist in positioning the window 40 on the image sensor die 30.

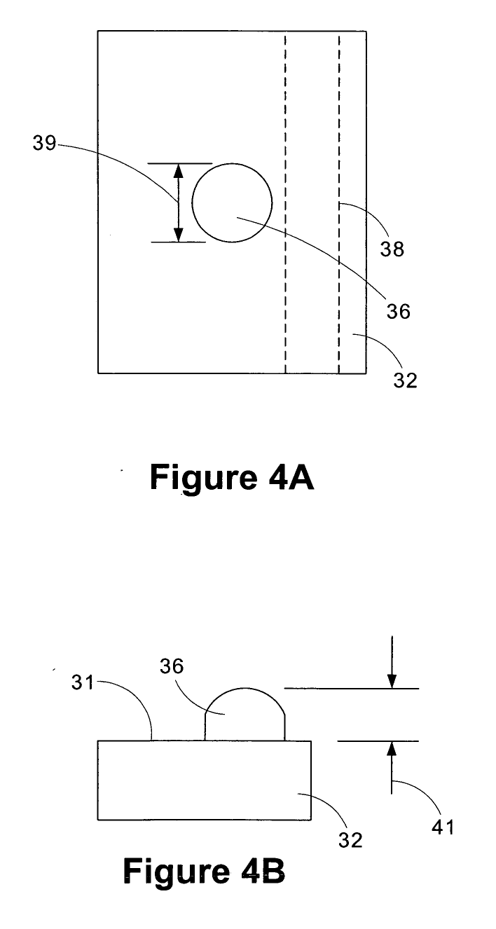

FIGS. 4A-4B depict illustrative examples of the window tilt control features 36 shown in FIG. 2B. As shown therein, the window tilt control features 36 may have a diameter 39 that ranges from approximately 30-70 μm and a height 41 that ranges from approximately 50-150 μm. Of course, such illustrative dimensions should not be considered as a limitation of the present invention.

FIG. 2D depicts yet another illustrative example of an image sensor die 30 comprised of a plurality of window tilt control features 36. In this illustrative example, the image sensor die 30 comprises two window tilt control features 36 that are positioned on opposite sides of the active area 34. As with the previous examples, the size of the window tilt control features 36 depicted in FIG. 2D may vary depending upon the particular application. For example, the relatively elongated window tilt control features 36 depicted in FIG. 2D may have a length of 60-80% of the side of the active area 34.

FIGS. 5A-5B are side views showing how the illustrative window tilt control features 36 may be used in reducing or eliminating tilt of the window 40 of the image sensor die 30. FIG. 5A depicts a plurality of illustrative line-type window tilt control features 36 (shown in dashed lines), whereas FIG. 5B depicts a plurality of illustrative rounded or ball shaped window tilt control features 36 (shown in dashed lines). After the window tilt control features 36 are formed, the line of adhesive 38 is positioned on the substrate 32. Thereafter, the window 40 is moved to its proper position. At this time, the window 40 may simply be dropped onto the adhesive 38 and the window tilt control features 36. Alternatively, if desired, a downward force, as indicated by the arrow 45, may be applied to the window 40 to insure that it engages the window tilt control features 36. The adhesive 38 is allowed to cure in accordance with normal practice, thereby securing the window 40 in position. Through use of the window tilt control features 36 described herein, the tilt of the window 40 may be reduced or eliminated.

The window tilt control features 36 described herein may be comprised of a variety of different materials and they may be manufactured using a variety of techniques. For example, the window tilt control features 36 may be comprised of an adhesive or epoxy type material that is the same as or different from the adhesive 38 used to secure the window 40 to the substrate 32. The epoxy or adhesive may be deposited (or “written”) in the desired shape (line-type feature as shown in FIG. 2A or 2D, or rounded-type features as shown in FIGS. 2B-2C) using any of a variety of known epoxy distribution tools. Thereafter, the window tilt control features 36 may be allowed to partially cure, e.g., approximately 70-80% cured. At this stage of cure, the epoxy window tilt control features 36 have sufficient rigidity to perform the functions of the window tilt control features 36 described herein. Of course, if desired, the epoxy window tilt control features 36 may be allowed to fully cure. After the epoxy window tilt control features 36 are formed, the line of adhesive material 38 may be positioned on the substrate 32 and the window 40 may be attached as described above.

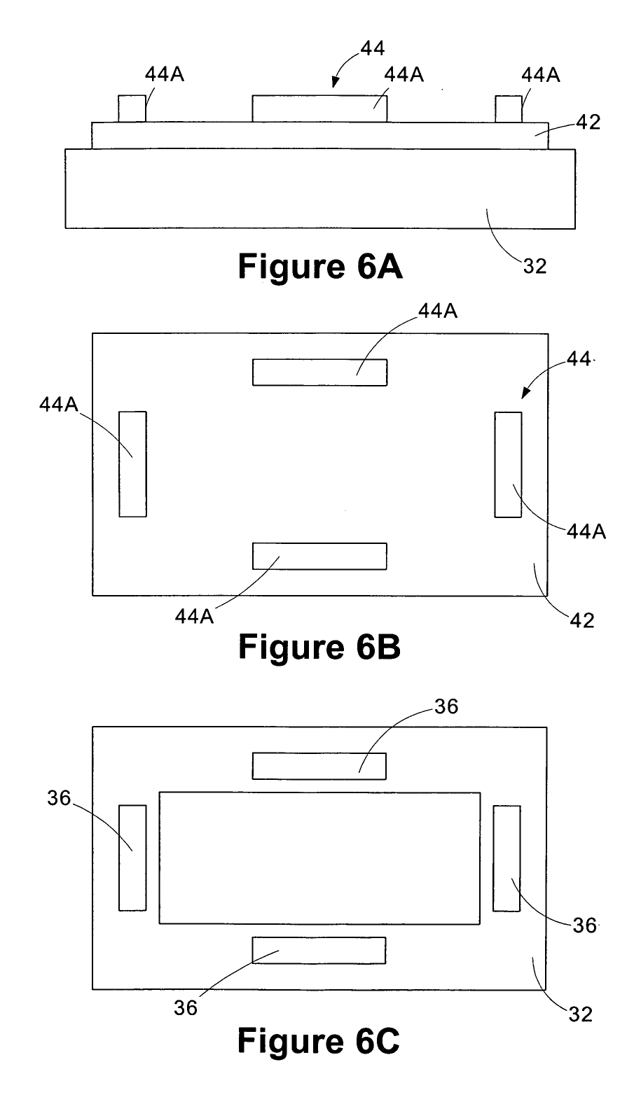

In another illustrative example, the window tilt control features 36 may be formed using traditional deposition, photolithography and etching processes, as shown in FIGS. 6A-6C. For example, the window tilt control features 36 may be formed by initially depositing a layer 42 of any desired material, e.g., silicon nitride, silicon dioxide, etc. If desired or necessary, the upper surface 43 of this deposited layer of material may be subjected to a planarization process, e.g., a chemical mechanical polishing process. Thereafter, a masking layer 44, e.g., a patterned layer of photoresist material, may be formed above the layer of material 42 using known photolithography tools and techniques. FIG. 6B is a top view of the masking layer 44 comprised of a plurality of masking features 44A. The masking features 44A correspond to the tilt control features 36 that will ultimately be formed from the layer 42. Thereafter, an anisotropic etching process may be performed to define the window tilt control features 36 (see FIG. 6C) from the deposited layer of material 42.

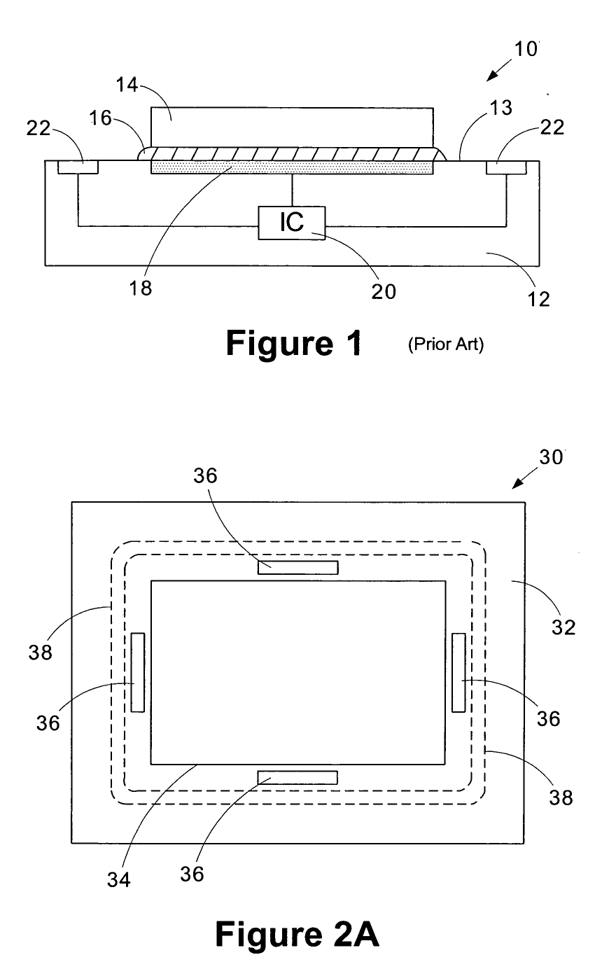

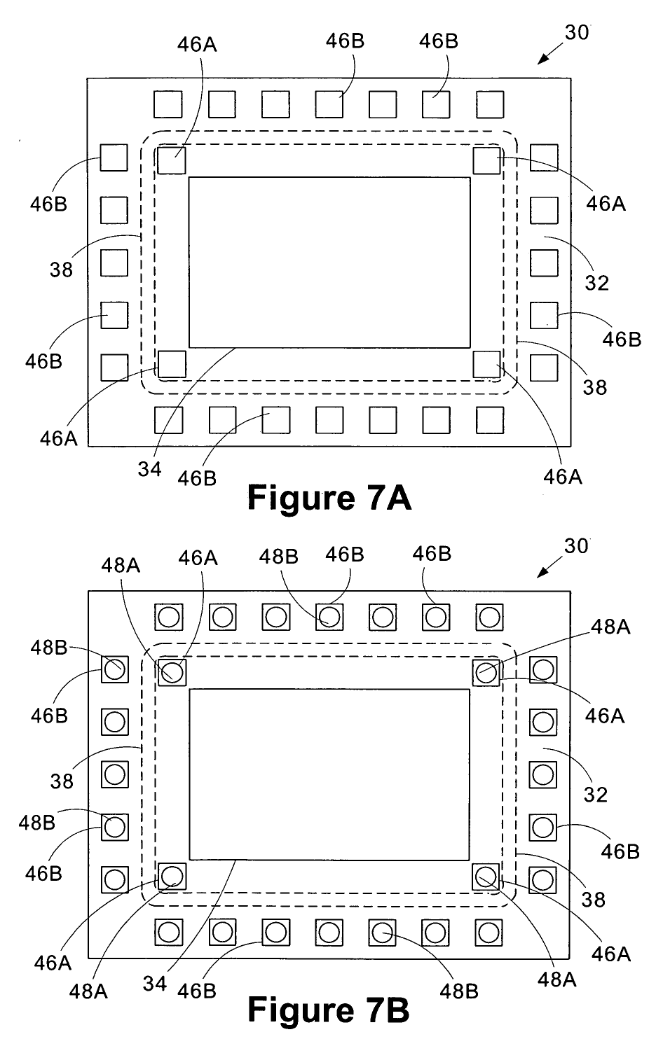

As yet another example, the window tilt control features 36 may be comprised of a non-functioning bond pad to which a non-functioning conductive member, e.g., ball, is attached. More specifically, as is well known to those skilled in the art, electrical connection between the image sensor die 10 (see FIG. 1) and its packaging (not shown) is typically accomplished by forming a ball of conductive material on the bond pads 22. In accordance with this illustrative aspect of the present invention, as shown in FIGS. 7A-7B, a plurality of non-functioning bond pad structures 46A may be formed on the substrate 32 during the process used to form functioning bond pads 46B for the image sensor die 30. Thereafter, a conductive ball of material 48A may be formed on the non-functioning pads 46A at the same time conductive balls of material 48B are formed on the functioning bond pads 46B for the image sensor die 30. The non-functioning balls of material 48A act as the window tilt control features 36 described herein.

The particular embodiments disclosed above are illustrative only, as the invention may be modified and practiced in different but equivalent manners apparent to those skilled in the art having the benefit of the teachings herein. For example, the process steps set forth above may be performed in a different order. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. An image sensor die, comprising:
a substrate comprising an active area formed therein;
a window positioned above said active area; and
a plurality of window tilt alignment features formed above said substrate, said window tilt alignment features being positioned between said window and said substrate.

2. The image sensor die of claim 1, wherein said plurality of window tilt alignment features comprises at least two window tilt alignment features.

3. The image sensor die of claim 1, wherein said plurality of window tilt alignment features comprises at least three window tilt alignment features.

4. The image sensor die of claim 1, wherein said plurality of window tilt alignment features comprises a plurality of line-type features.

5. The image sensor die of claim 1, wherein said plurality of window tilt alignment features comprises a plurality of rounded-type features.

6. The image sensor die of claim 1, wherein said plurality of window tilt alignment features comprises two window tilt alignment features, each of which are positioned on opposite sides of said active area.

7. The image sensor die of claim 1, wherein said plurality of window tilt alignment features comprises four window tilt alignment features, each of which is positioned proximate a side of said active area.

8. The image sensor die of claim 1, wherein said plurality of window tilt alignment features comprises four window tilt alignment features, each of which is positioned proximate a corner of said active area.

9. The image sensor die of claim 1, wherein said plurality of window tilt alignment features comprises three window tilt alignment features, said three window tilt alignment features being arranged in a triangular pattern around said active area.

10. The image sensor die of claim 1, wherein each of said plurality of window tilt alignment features are physically separate from one another.

11. The image sensor die of claim 1, wherein said plurality of window tilt alignment features are comprised of an adhesive material.

12. The image sensor die of claim 1, wherein said plurality of window tilt alignment features are comprised of a layer of material that is deposited above said substrate and etched.

13. The image sensor die of claim 1, wherein said plurality of window tilt alignment features are comprised of an electrically conductive material.

14. The image sensor die of claim 1, wherein said window contacts each of said plurality of window tilt alignment features.

15. An image sensor die, comprising:
a substrate comprising an active area formed therein;
a window positioned above said active area; and
two window tilt alignment features formed above said substrate, each of which are positioned on opposite sides of said active area, said window tilt alignment features being positioned between said window and said substrate, wherein said window contacts each of said window tilt alignment features.

16. The image sensor die of claim 15, wherein each of said window tilt alignment features are physically separate from one another.

17. The image sensor die of claim 15, wherein said window tilt alignment features are comprised of an adhesive material.

18. The image sensor die of claim 15, wherein said window tilt alignment features are comprised of a layer of material that is deposited above said substrate and etched.

19. The image sensor die of claim 15, wherein said window tilt alignment features are comprised of an electrically conductive material.

20. An image sensor die, comprising:
a substrate comprising an active area formed therein;
a window positioned above said active area; and
four window tilt alignment features formed above said substrate, each of which is positioned proximate a side of said active area, said window tilt alignment features being positioned between said window and said substrate, wherein said window contacts each of said window tilt alignment features.

21. The image sensor die of claim 20, wherein each of said window tilt alignment features are physically separate from one another.

22. The image sensor die of claim 20, wherein said window tilt alignment features are comprised of an adhesive material.

23. The image sensor die of claim 20, wherein said window tilt alignment features are comprised of a layer of material that is deposited above said substrate and etched.

24. The image sensor die of claim 20, wherein said window tilt alignment features are comprised of an electrically conductive material.

25. An image sensor die, comprising:
a substrate comprising an active area formed therein;
a window positioned above said active area; and
four window tilt alignment features formed above said substrate, each of which is positioned proximate a corner of said active area, said window tilt alignment features being positioned between said window and said substrate, wherein said window contacts each of said window tilt alignment features.

26. The image sensor die of claim 25, wherein each of said window tilt alignment features are physically separate from one another.

27. The image sensor die of claim 25, wherein said window tilt alignment features are comprised of an adhesive material.

28. The image sensor die of claim 25, wherein said window tilt alignment features are comprised of a layer of material that is deposited above said substrate and etched.

29. The image sensor die of claim 25, wherein said window tilt alignment features are comprised of an electrically conductive material.

30. An image sensor die, comprising:
a substrate comprising an active area formed therein;
a window positioned above said active area; and
three window tilt alignment features formed above said substrate, said three window tilt alignment features being arranged in a triangular pattern around said active area, said window tilt alignment features being positioned between said window and said substrate, wherein said window contacts each of said window tilt alignment features.

31. The image sensor die of claim 30, wherein each of said plurality of window tilt alignment features are physically separate from one another.

32. The image sensor die of claim 30, wherein said plurality of window tilt alignment features are comprised of an adhesive material.

33. The image sensor die of claim 30, wherein said plurality of window tilt alignment features are comprised of a layer of material that is deposited above said substrate and etched.

34. The image sensor die of claim 30, wherein said plurality of window tilt alignment features are comprised of an electrically conductive material.

35. A method, comprising:
forming a plurality of window tilt alignment features above a substrate of an image sensor die, said substrate comprising an active area;
after forming said plurality of window tilt alignment features, forming an adhesive material on said substrate;
positioning a window above said active area; and
contacting said window with said adhesive material.

36. The method of claim 35, wherein forming said plurality of window tilt alignment features above said substrate comprises forming at least two window tilt alignment features above said substrate.

37. The method of claim 35, wherein forming said plurality of window tilt alignment features above said substrate comprises forming at least three window tilt alignment features above said substrate.

38. The method of claim 35, wherein forming said plurality of window tilt alignment features above said substrate comprises forming a plurality of line-type window tilt alignment features above said substrate.

39. The method of claim 35, wherein forming said plurality of window tilt alignment features above said substrate comprises forming a plurality of rounded-type window tilt alignment features above said substrate.

40. The method of claim 35, wherein forming said plurality of window tilt alignment features above said substrate comprises forming two window tilt alignment features above said substrate, each of which are positioned on opposite sides of said substrate.

41. The method of claim 35, wherein forming said plurality of window tilt alignment features above said substrate comprises forming four window tilt alignment features above said substrate, each of which is positioned proximate a side of said active area.

42. The method of claim 35, wherein forming said plurality of window tilt alignment features above said substrate comprises forming four window tilt alignment features above said substrate, each of which is positioned proximate a corner of said active area.

43. The method of claim 35, wherein forming said plurality of window tilt alignment features above said substrate comprises forming three window tilt alignment features above said substrate, said three window tilt alignment features being arranged in a triangular pattern around said active area.

44. The method of claim 35, wherein forming said plurality of window tilt alignment features above said substrate comprises forming a plurality of line-type window tilt alignment features above said substrate, each of said plurality of line-type window tilt alignment features being physically separate from one another.

45. The method of claim 35, wherein forming said plurality of window tilt alignment features comprises forming said plurality of window tilt alignment features from an adhesive material and allowing said plurality of window tilt alignment features to at least partially cure prior to forming said adhesive material on said substrate.

46. The method of claim 35, wherein forming said plurality of window tilt alignment features comprises:
forming a layer of material above said substrate;
forming a masking layer above said layer of material; and
performing an etching process to define said plurality of window tilt alignment features in said layer of material using said masking layer as an etch mask.

47. The method of claim 35, wherein forming said plurality of window tilt alignment features comprises forming said plurality of window tilt alignment features from a conductive material.

48. The method of claim 35, wherein contacting said window with said adhesive material comprises urging said window into contact with at least one of said plurality of window tilt alignment features.

49. A method, comprising:
forming a plurality of window tilt alignment features above a substrate of an image sensor die, said substrate comprising an active area, wherein said plurality of window tilt alignment features are formed from a first adhesive material and are allowed to at least partially cure;
after forming said plurality of window tilt alignment features, forming a second adhesive material on said substrate;
positioning a window above said active area; and
contacting said window with said second adhesive material.

50. The method of claim 49, wherein forming said plurality of window tilt alignment features above said substrate comprises forming two window tilt alignment features above said substrate, each of which are positioned on opposite sides of said substrate.

51. The method of claim 49, wherein forming said plurality of window tilt alignment features above said substrate comprises forming four window tilt alignment features above said substrate, each of which is positioned proximate a side of said active area.

52. The method of claim 49, wherein forming said plurality of window tilt alignment features above said substrate comprises forming four window tilt alignment features above said substrate, each of which is positioned proximate a corner of said active area.

53. The method of claim 49, wherein forming said plurality of window tilt alignment features above said substrate comprises forming three window tilt alignment features above said substrate, said three window tilt alignment features being arranged in a triangular pattern around said active area.

54. The method of claim 49, wherein contacting said window with said second adhesive material comprises urging said window into contact with at least one of said plurality of window tilt alignment features.

55. The method of claim 49, wherein said first adhesive material and said second adhesive material are comprised of the same material.

56. The method of claim 49, wherein said first adhesive material and said second adhesive material are comprised of the different materials.

57. A method, comprising:
forming a plurality of window tilt alignment features above a substrate of an image sensor die, said substrate comprising an active area, said forming of said plurality of window tilt control features comprising:
forming a layer of material above said substrate;
forming a masking layer above said layer of material; and
performing an etching process to define said plurality of window tilt alignment features in said layer of material using said masking layer as an etch mask;
after forming said plurality of window tilt alignment features, forming an adhesive material on said substrate;
positioning a window above said active area; and
contacting said window with said adhesive material.

58. The method of claim 57, wherein forming said plurality of window tilt alignment features above said substrate comprises forming two window tilt alignment features above said substrate, each of which are positioned on opposite sides of said substrate.

59. The method of claim 57, wherein forming said plurality of window tilt alignment features above said substrate comprises forming four window tilt alignment features above said substrate, each of which is positioned proximate a side of said active area.

60. The method of claim 57, wherein forming said plurality of window tilt alignment features above said substrate comprises forming four window tilt alignment features above said substrate, each of which is positioned proximate a corner of said active area.

61. The method of claim 57, wherein forming said plurality of window tilt alignment features above said substrate comprises forming three window tilt alignment features above said substrate, said three window tilt alignment features being arranged in a triangular pattern around said active area.

62. The method of claim 57, wherein forming said plurality of window tilt alignment features comprises forming said plurality of window tilt alignment features from a conductive material.

63. The method of claim 57, wherein contacting said window with said adhesive material comprises urging said window into contact with at least one of said plurality of window tilt alignment features.

64. A method, comprising:
forming a plurality of window tilt alignment features comprised of a conductive material above a substrate of an image sensor die, said substrate comprising an active area;
after forming said plurality of window tilt alignment features, forming an adhesive material on said substrate;
positioning a window above said active area; and
contacting said window with said adhesive material.

65. The method of claim 64, wherein forming each of said window tilt alignment features comprises:
forming a non-functioning bond pad; and
forming said conductive material on said non-functioning bond pad.

66. The method of claim 64, wherein forming said plurality of window tilt alignment features above said substrate comprises forming four window tilt alignment features above said substrate, each of which is positioned proximate a side of said active area.

67. The method of claim 64, wherein forming said plurality of window tilt alignment features above said substrate comprises forming four window tilt alignment features above said substrate, each of which is positioned proximate a corner of said active area.

68. The method of claim 64, wherein forming said plurality of window tilt alignment features above said substrate comprises forming three window tilt alignment features above said substrate, said three window tilt alignment features being arranged in a triangular pattern around said active area.

69. The method of claim 64, wherein contacting said window with said adhesive material comprises urging said window into contact with at least one of said plurality of window tilt alignment features.
